(19) United States
(12) Patent Application Publication
(10) Pub. No.: US 2008/0180434 A1
(43) Pub. Date: Jul. 31, 2008

(54) Plenoptic display with automated alignment

(76) Inventor: Amir Said, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/701,023

(22) Filed: Jan. 31, 2007

(51) Int. Cl. G06T 15/00

(52) U.S. Cl. 345/419

(57) ABSTRACT

One embodiment pertains to an apparatus for displaying three-dimensional views of an image where the image seen depends on a viewing angle. The apparatus includes at least a plurality of tiles, a plenoptic function projection, and alignment mechanisms. Each tile includes an array of lenses on a front side of a transparent base, and the plenoptic function projection is configured on a back side of the transparent base. The alignment mechanisms are configured to independently align each tile to the plenoptic function projection so that the three-dimensional views of the image are properly displayed. Other embodiments, aspects and features are also disclosed.

### BACKGROUND

1. Technical Field

The present application relates generally to three-dimensional display technologies and methods of displaying three-dimensional views of an image.

2. Description of the Background Art

There is a variety of display methods for simulating three-dimensional views that use only the stereo views, where different images are delivered to the left and right eyes. One problem with these stereo viewing technologies is that the perception of depth does not depend only on the disparity between the images in the left and right eyes. Rather, the perception of depth is also influenced by the ability of the eyes to focus at different distances and by the changes in parallax that occur with small head movements. Consequently, the three-dimensional perceptions produced by stereo display may be preceived to be “fake 3-D”. Furthermore, the stereo displays may cause unwanted stress on the eye muscles as the eyes constantly change focus trying to accommodate conflicting depth clues.

Using a different technique, holograms can create a true plenoptic display of a three-dimensional object, without the problems mentioned above. However, the plenoptic surface of a hologram is created using light interference, and thus laser light is the most reliable way of creating and reproducing the hologram. Unfortunately, using laser sources for large display areas is not very convenient to use, and the resulting images are monochromatic. Holograms created for white light are typically much more convenient to use, but they are significantly more limited and less realistic. One limitation of holograms is that they are generally limited to displaying objects. For example, holograms of landscapes and other views of large areas are generally not created.

Another problem with holograms is that the interference pattern is very detailed. In other words, the interference information needs to be at a very high resolution depending on the light wavelength. Consequently, the hologram creation process is extremely sensitive. First, it needs film with very small grain. Second, even tiny vibrations caused by sound can ruin a hologram, so the optical equipment needs to be in a carefully controlled environment. Finally, the use of special film makes it impractical or very expensive to create holograms that are large.

### BRIEF DESCRIPTION OF THE DRAWINGS

FIG. 1 is a cross-sectional view of a plenoptic display array in accordance with an embodiment of the invention.

FIG. 2 is a planar view of a plenoptic display array in accordance with an embodiment of the invention.

FIGS. 3A and 3B are cross-sectional views illustrating the operation of a cell of a plenoptic display array in accordance with an embodiment of the invention.

FIG. 4A is a planar view of an apparatus for a plenoptic display with automatic alignment in accordance with an embodiment of the invention.

FIG. 4B is a planar view of an apparatus for a plenoptic display with automatic alignment in accordance with another embodiment of the invention.

FIG. 5 is a schematic diagram depicting an example alignment pattern detector in accordance with an embodiment of the invention.

FIG. 6 is a schematic diagram depicting an example alignment pattern in accordance with an embodiment of the invention.

FIG. 7A is a schematic diagram showing an overlapping position of the alignment pattern detector of FIG. 5 and the alignment pattern of FIG. 6 when both vertical and horizontal alignment are achieved in accordance with an embodiment of the invention.

FIG. 7B is a schematic diagram showing an overlapping position of the alignment pattern detector of FIG. 5 and the alignment pattern of FIG. 6 with vertical alignment and horizontal misalignment.

FIG. 7C is a schematic diagram showing an overlapping position of the alignment pattern detector of FIG. 5 and the alignment pattern of FIG. 6 with horizontal alignment and vertical misalignment.

FIG. 7D is a schematic diagram showing an overlapping position of the alignment pattern detector of FIG. 5 and the alignment pattern of FIG. 6 with both vertical and horizontal misalignment.

### SUMMARY

One embodiment relates to an apparatus for displaying three-dimensional views of an image where the image seen depends on a viewing angle. The apparatus includes at least a plurality of tiles, a projection of a plenoptic function to a two-dimensional space, and alignment mechanisms. Each tile includes an array of lenses on a front side of a transparent base, and the plenoptic function projection is configured on a back side of the transparent base. The alignment mechanisms are configured to independently align each tile to the plenoptic function so that the three-dimensional views of the image are properly displayed.

Another embodiment relates to a method for automated alignment of a plurality of tiles, each tile including an optical arrangement for transforming a section of a plenoptic function projection into a three-dimensional image. A horizontal misalignment and a vertical misalignment are determined between each tile and the plenoptic function projection. The horizontal misalignment and the vertical misalignment are corrected by activating horizontal and vertical microactuators so as to adjust the horizontal and vertical positions of the tile relative to the plenoptic function projection.

Another embodiment relates to an apparatus for automated alignment of a plenoptic three-dimensional display. The apparatus includes at least an optical arrangement, a plurality of tiles, alignment detectors and actuators. The optical arrangement is configured to transform a plenoptic function projection into a three-dimensional image, and the plurality of tiles is configured such that each tile holds a section of the plenoptic function projection. The alignment detectors are configured to determine misalignment between each tile and the optical arrangement, and the actuators are configured to correct any detected misalignment by adjusting a position of each tile relative to the optical arrangement.

Another embodiment relates to a method for automated alignment of a plurality of tiles to an optical arrangement, wherein each tile is configured to hold a section of a plenoptic function projection, and wherein the optical arrangement is configured to transform the plenoptic function projection into a three-dimensional image. The method comprises detecting a misalignment between each tile and the optical arrangement, and correcting any detected misalignment for a tile by activating microactuators so as to adjust a position of the tile relative to the optical arrangement.

Other embodiments, aspects and features are also disclosed.

### DETAILED DESCRIPTION

The present disclosure pertains to display technology that utilize plenoptic functions. Plenoptic functions are generally six-dimensional functions. Plenoptic displays transform two-dimensional projections of plenoptic functions to produce visual images that look very realistically like three-dimensional images, where the image seen by a viewer depends on the viewing angle.

Plenoptic displays typically require the optical masks, micro-lenses, or micro-mirrors to be configured such that the light corresponding to each display dot of a two-dimensional projection of the plenoptic function comes out in the proper angle. The applicant has determined that one problem with using a contiguous optical mask and a contiguous plenoptic function projection is that, due to small mechanical imperfections, the optical mask and/or the plenoptic function projection may not have the required accuracy for precise alignment over an entire display. For example, the printing, display or projection process for creating the plenoptic function projection may not be able to guarantee the required precision in the position of the plenoptic function projection as printed (or displayed or projected) over large areas.

The present application discloses the use of tiles to break up the optical mask so as to overcome this problem by allowing for the tiles to be individually aligned to the local areas of the plenoptic function projection. Alternatively, the present application discloses the use of tiles to break up the plenoptic function projection so as to overcome this problem by allowing for the tiles holding sections of the plenoptic function projection to be individually aligned to the local areas of the optical mask.

In other words, by using several movable sections, each section may be properly aligned with very good precision. By using this technique, precise alignment between the optical arrangement and the underlying dots of the plenoptic function projection becomes achievable over a large area with high precision.

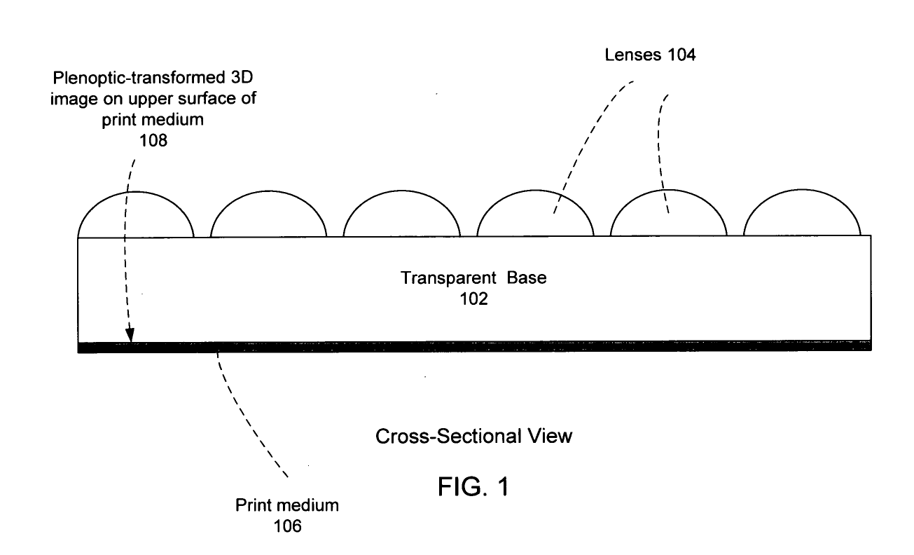

FIG. 1 is a cross-sectional view of a plenoptic display array in accordance with an embodiment of the invention. The array includes a plurality of lenses 104 on a front side of a transparent base 102. A high-resolution print medium 106 may be positioned on a back side of the transparent base 102. The front side of the print medium 106 includes a high-resolution two-dimensional projection of a plenoptic function (plenoptic-transformed 3D image) 108 which includes visual information needed for displaying three-dimensional views of an image.

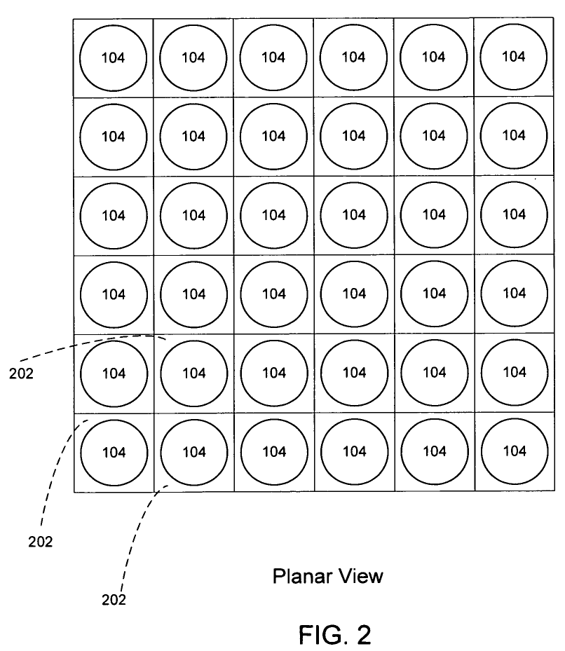

FIG. 2 is a planar view of a plenoptic display array in accordance with an embodiment of the invention. In this embodiment, the lenses 104 are arranged in an array of square-shaped cells 202 on the front side of the transparent base. In a different embodiment, the lenses may be arranged in an array of hexagonal-shaped cells.

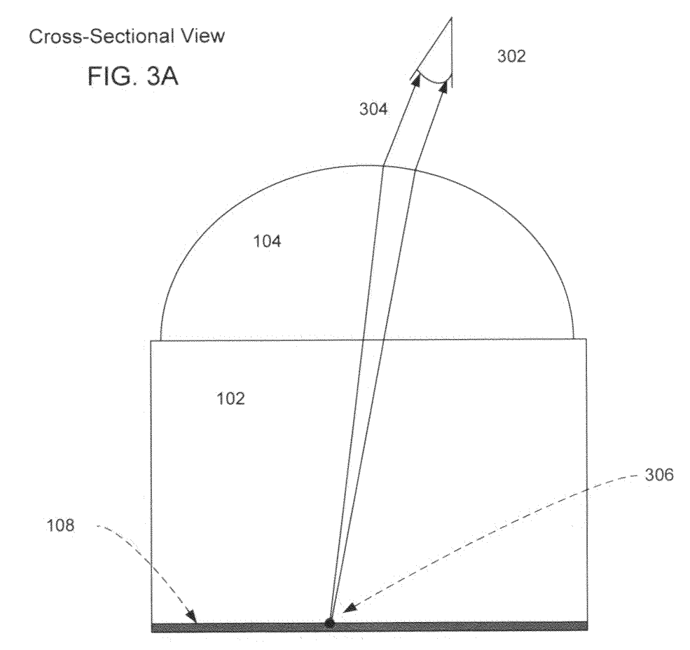

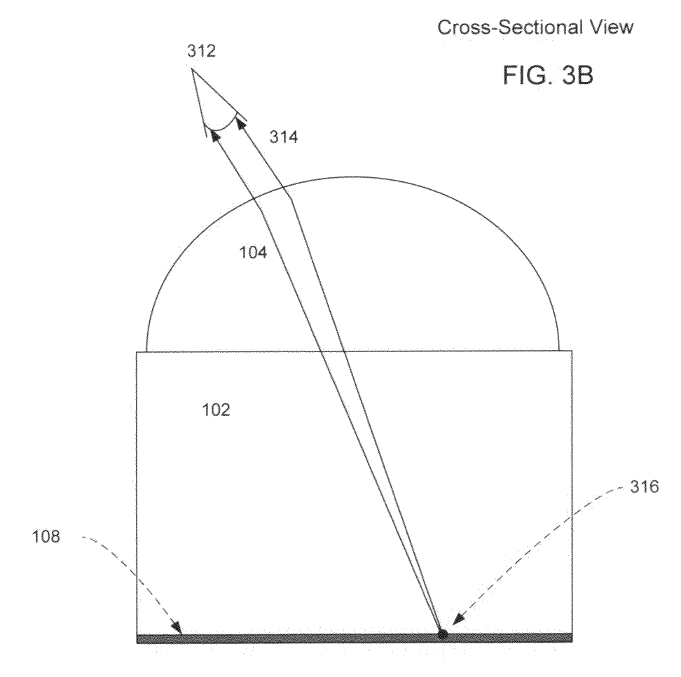

Each of the lenses 104 provides a picture element or pixel of the image viewed. However, unlike two-dimensional displays, the color and/or intensity of the pixel provided by a lens 104 varies depending upon the viewing angle at which the display is seen. In other words, the plenoptic display apparatus provides a three-dimensional viewing experience, similar to looking at an actual three-dimensional object. This three-dimensional viewing aspect is discussed further below in relation to FIGS. 3A and 3B.

FIGS. 3A and 3B are cross-sectional views illustrating the operation of a cell of a plenoptic display array in accordance with an embodiment of the invention. For purposes of explanation, FIG. 3A is a ray diagram pertaining to a first view angle 302, and FIG. 3B is a ray diagram pertaining to a second (different) view angle 312.

As seen in FIG. 3A, an observer at the first view angle 302 sees approximately parallel light rays 304 from the illustrated cell. The parallel light rays 304 are traced back to a first focal point 306 on the high-resolution image 108. The color and intensity of light from the cell (i.e. of the pixel) when viewed from the first view angle 302 is determined or substantially determined by the color and intensity of light emitted or reflected by this first focal point 306.

Similarly, as seen in FIG. 3B, an observer at the second view angle 312 sees a different set of approximately parallel light rays 314 from the illustrated cell. These parallel light rays 314 are traced back to a second focal point 316 on the high-resolution image 108. The color and intensity of light from the cell (i.e. of the pixel) when viewed from the first view angle 312 is determined or substantially determined by the color and intensity of light emitted or reflected by this second focal point 316.

In other words, each point in the high-resolution image corresponds to what is seen at a particular viewing angle from a cell or pixel of the plenoptic display. Hence, the plenoptic display may show different images (for example, different perspectives of a three-dimensional object) at different viewing angles.

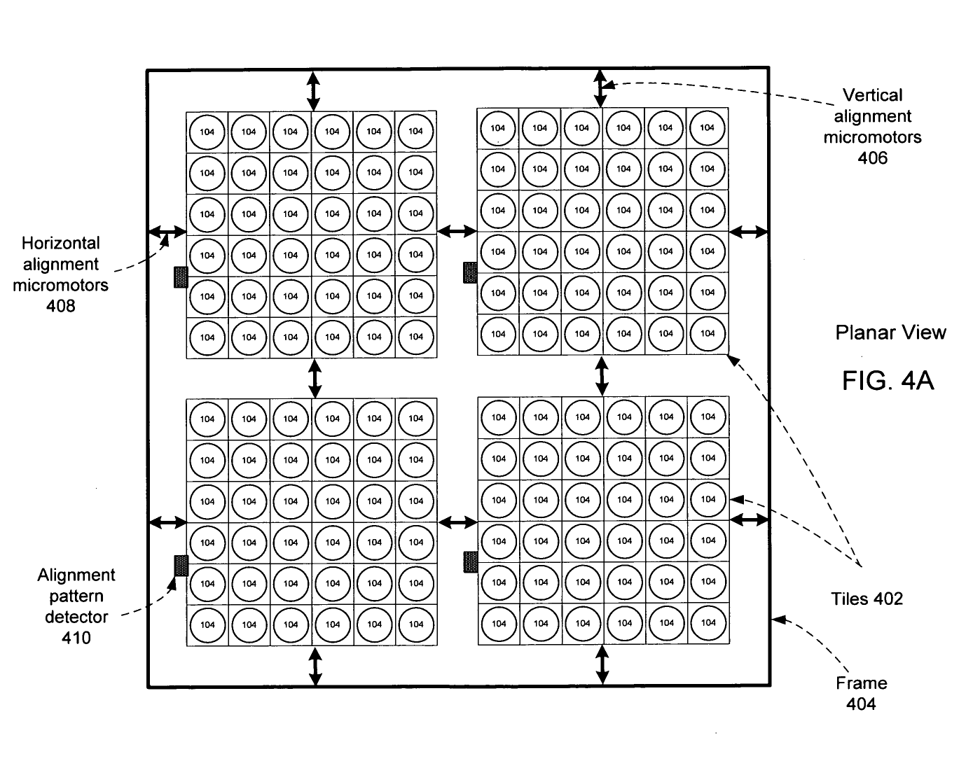

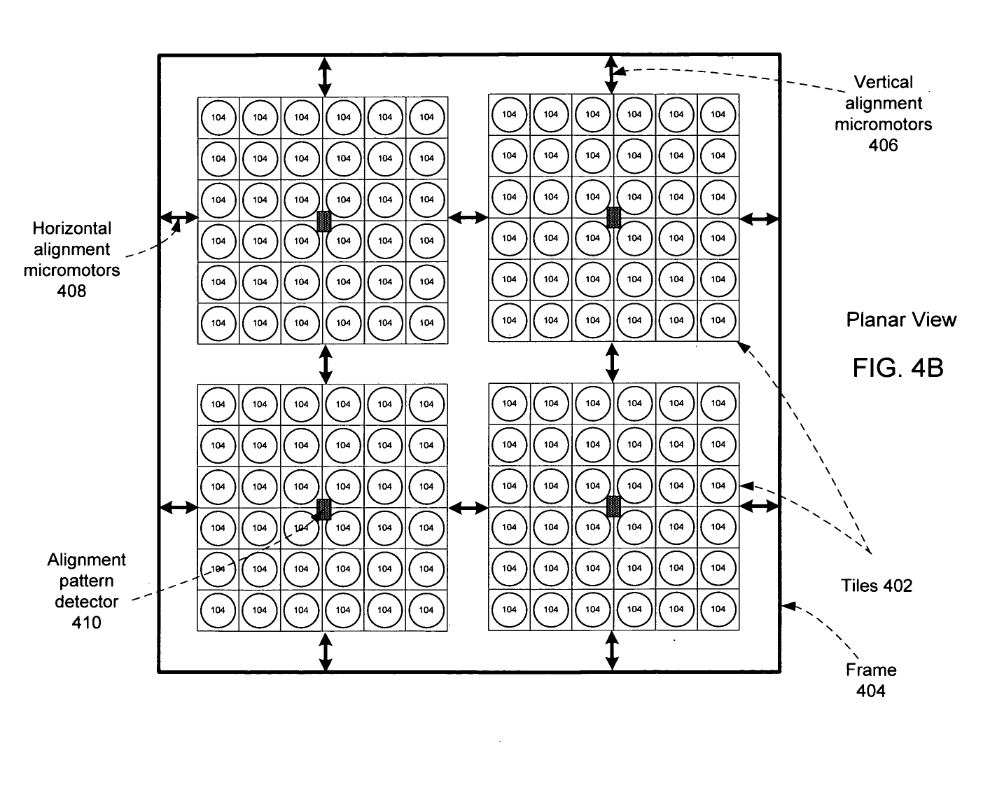

FIG. 4A is a planar view of an apparatus for a plenoptic display with automatic alignment in accordance with an embodiment of the invention. In this embodiment, multiple tiles 402 are provided, where each tile 402 includes an array of cells 202 for the plenoptic display. The tiles 402 may be arranged and positioned within a frame 404.

While only four 6×6 tiles 402 are shown in FIG. 4, an actual implementation would be expected to have larger arrays of cells per tile 402 and may have more tiles 402 within a frame 404. Also, while the gaps between tiles 402 and between the frame 404 and the tiles 402 are shown to be relatively large for ease of illustration and purposes of discussion, an actual implementation would be expected to have much narrower gaps, where the width of each gap was a fraction of a cell dimension.

In accordance with an embodiment of the invention, vertical alignment micromotors 406 and horizontal alignment micromotors 408 may be configured between tiles 402 and also between the frame 404 and the tiles 402. In one implementation, these micromotors may controllably expand or contract so as to shift the tiles vertically (by the vertical alignment micromotors 406) or horizontally (by the horizontal alignment micromotors 408). Although the micromotors are shown in the gaps between tiles 402 and also between the frame 404 and the tiles 402, portions of the micromotors may extend to the interior of the tiles 402 and/or into the frame 404.

Furthermore, an alignment pattern detector (sensor) 410 may be attached to each of the tiles 402. In the embodiment shown in FIG. 4A, the detectors 410 are shown attached to at a position on the periphery of tiles 402. In the embodiment shown in FIG. 4B, the detectors 410 are shown positioned in the interior of the tiles 402.

The apparatus may also be configured such that a printed medium 106 with a two-dimensional projection of a plenoptic function (plenoptic-transformed 3D image) 108 is attached behind the tiles 402. The plenoptic function projection may be generated using an algorithm implemented in computer software and may be printed on a high-resolution medium, for example. The plenoptic function projection may comprise dots which are arranged so as to provide three-dimensional views of an image where the image seen depends on the viewing angle. In addition, alignment patterns may be incorporated into the plenoptic function for use in aligning the plenoptic function projection 108 to the lens arrays of the tiles 402.

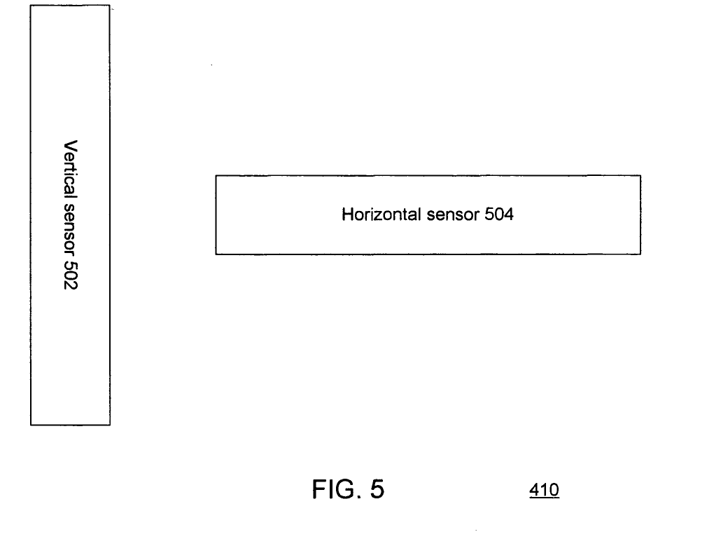

FIG. 5 is a schematic diagram depicting an example alignment pattern detector 410 in accordance with an embodiment of the invention. In this example, the alignment pattern detector 410 includes a vertical sensor 502 and a horizontal sensor 504. As discussed further below, the vertical sensor 502 may be utilized to detect horizontal alignment, and the horizontal sensor 504 may be utilized to detect vertical alignment. Other implementations of an alignment pattern detector 410 may be used in alternative embodiments.

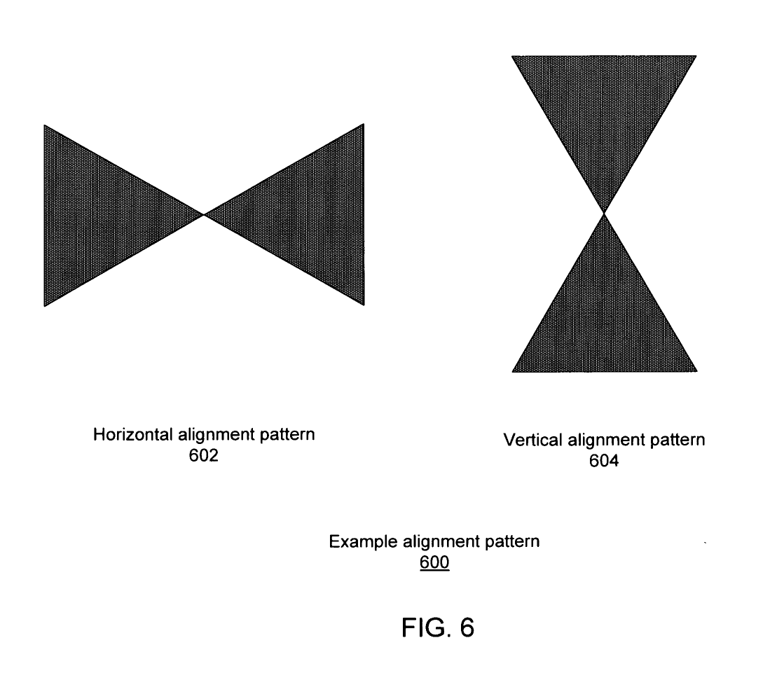

FIG. 6 is a schematic diagram depicting an example alignment pattern 600 in accordance with an embodiment of the invention. The alignment pattern 600 may include sub-patterns which are incorporated into and positioned precisely within the high-resolution plenoptic function projection 108 in accordance with an embodiment of the invention. The precise positioning of the alignment pattern is such that when a tile 402 is positioned correctly relative to the plenoptic function projection 108 below it, then the alignment pattern detector 410 is aligned with the alignment pattern 600. The example alignment pattern 600 shown includes a horizontal alignment pattern 602 and a vertical alignment pattern 604. As discussed further below, the horizontal alignment pattern 602 may be used in conjunction with the vertical sensor 502 for purposes of horizontal alignment, and the vertical alignment pattern 604 may be used in conjunction with the horizontal sensor 504 for purposes of vertical alignment.

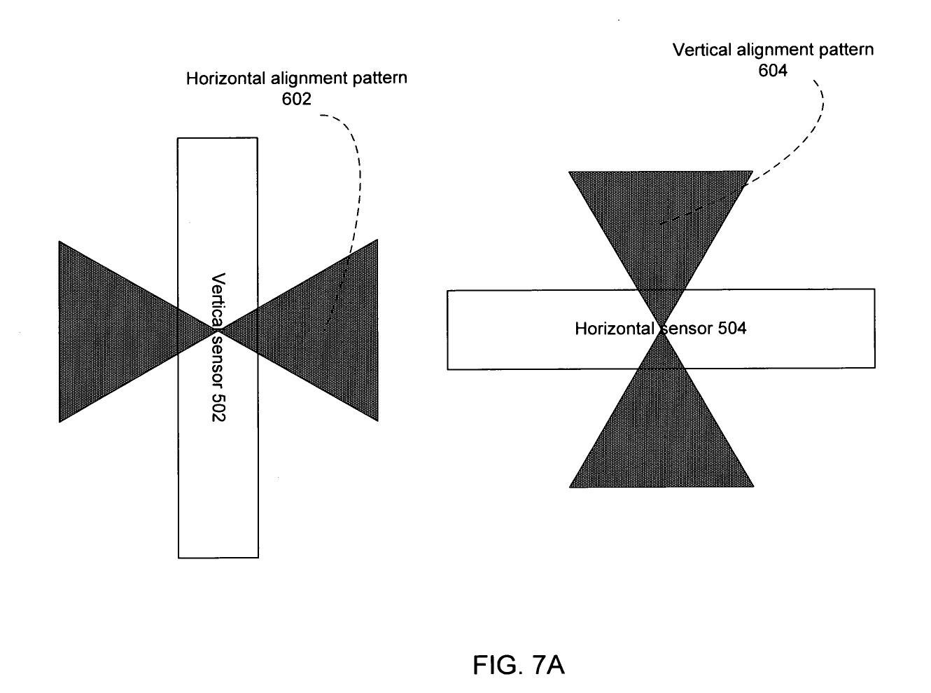

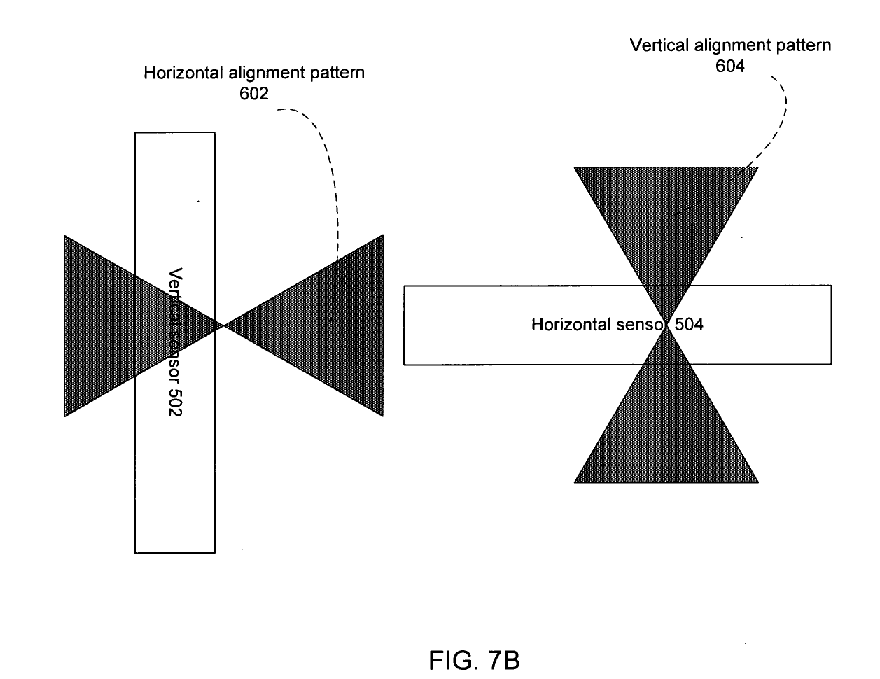

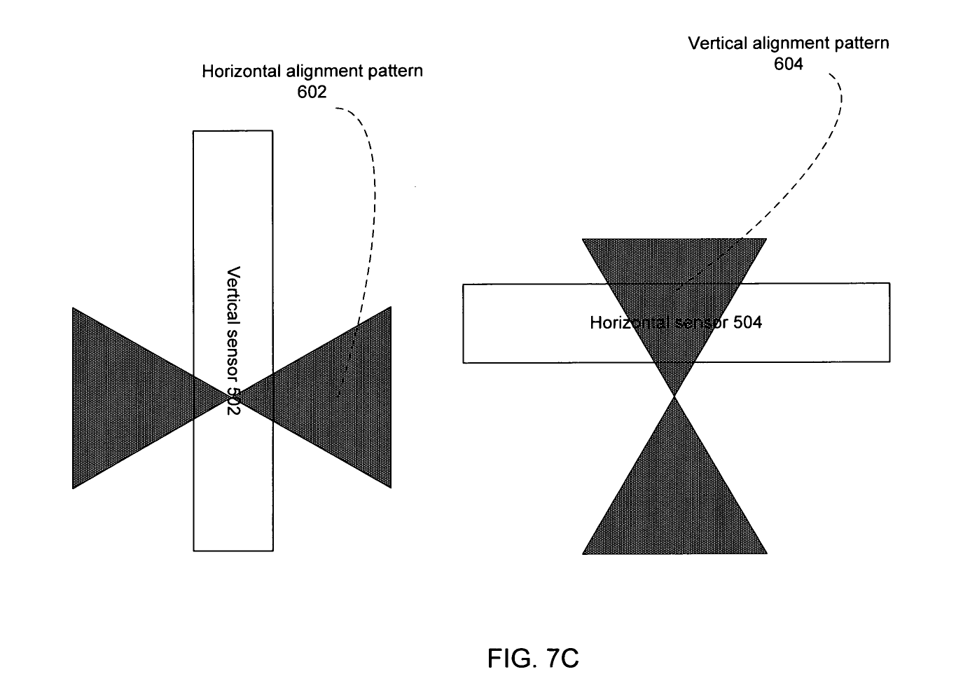

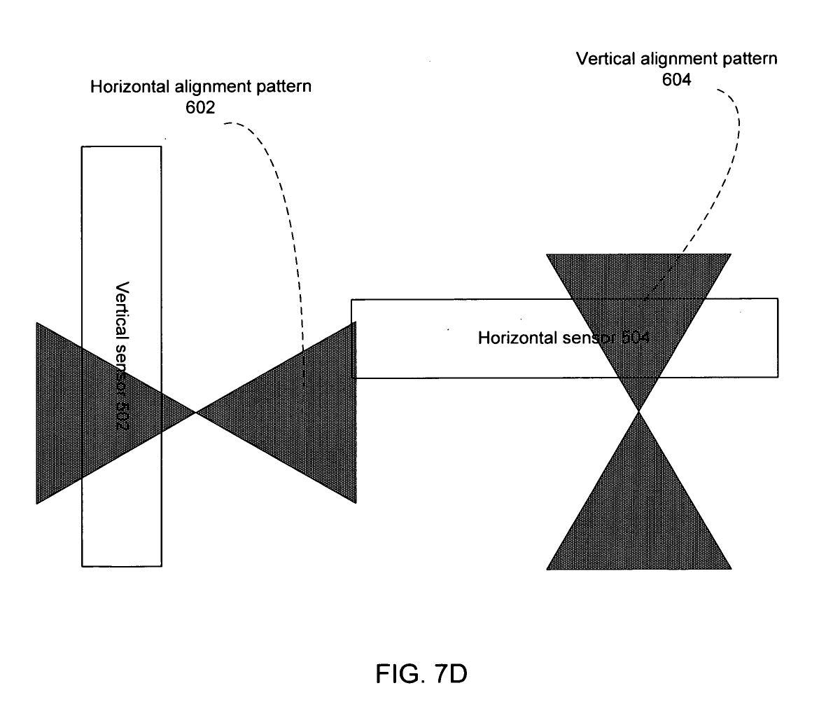

FIG. 7A is a schematic diagram showing an overlapping position of the alignment pattern detector 410 of FIG. 5 and the alignment pattern 600 of FIG. 6 when both vertical and horizontal alignment are achieved in accordance with an embodiment of the invention. As shown, horizontal alignment is achieved when the vertical sensor 502 is positioned along the horizontal dimension such that it is at the middle of the horizontal alignment pattern 602. Similarly, vertical alignment is achieved when the horizontal sensor 504 is positioned along the vertical dimension such that it is at the middle of the vertical alignment pattern 604.

FIG. 7B is a schematic diagram showing an overlapping position of the alignment pattern detector 410 of FIG. 5 and the alignment pattern 600 of FIG. 6 with vertical alignment and horizontal misalignment. As shown, vertical alignment is achieved when the horizontal sensor 504 is positioned along the vertical dimension such that it is at the middle of the vertical alignment pattern 604. However, horizontal misalignment is shown because the vertical sensor 502 is positioned to the left (i.e. not in the middle) of the horizontal alignment pattern lo 602.

FIG. 7C is a schematic diagram showing an overlapping position of the alignment pattern detector 410 of FIG. 5 and the alignment pattern 600 of FIG. 6 with horizontal alignment and vertical misalignment. As shown, horizontal alignment is achieved when the vertical sensor 502 is positioned along the horizontal dimension such that it is at the middle of the horizontal alignment pattern 602. However, vertical misalignment is shown because the horizontal sensor 504 is positioned above (i.e. not in the middle) of the vertical alignment pattern 604.

FIG. 7D is a schematic diagram showing an overlapping position of the alignment pattern detector 410 of FIG. 5 and the alignment pattern 600 of FIG. 6 with both vertical and horizontal misalignment. Horizontal misalignment is shown because the vertical sensor 502 is positioned to the left (i.e. not in the middle) of the horizontal alignment pattern 602. Vertical misalignment is shown because the horizontal sensor 504 is positioned above (i.e. not in the middle) of the vertical alignment pattern 604.

While the above-discussed embodiment describes a specific implementation using printed material and micro-lenses, in general, embodiments of such a plenoptic display may utilize printed material, film, active digital displays, or projectors combined appropriately with optical masks, micro-lenses, or micro-mirrors to reproduce a three-dimensional scene. In the case of a projector, micro-actuators are not utilized. Instead, the projected images may be electronically pre-processed to perform the proper spatial shifts for alignment purposes.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An apparatus for displaying three-dimensional views of an image where the image seen depends on a viewing angle, the apparatus comprising:
a plurality of tiles, each tile including an array of lenses on a front side of a transparent base;
a plenoptic function projection configured on a back side of the transparent base; and
alignment mechanisms to independently align each tile to the plenoptic function projection so that the three-dimensional views of the image are properly displayed.

2. The apparatus of claim 1, wherein the alignment mechanisms include alignment patterns incorporated with the plenoptic function projection and alignment pattern detectors coupled with said tiles.

3. The apparatus of claim 2, wherein the alignment pattern detectors include vertical sensors configured to determine a horizontal alignment and horizontal sensors configured to determine a vertical alignment.

4. The apparatus of claim 1, wherein the alignment mechanisms include vertical alignment microactuators and horizontal alignment microactuators.

5. The apparatus of claim 4, wherein the microactuators comprise micromotors having controllable screw mechanisms.

6. A method for automated alignment of a plurality of tiles, each tile including an optical arrangement for transforming a section of a two-dimensional projection of a plenoptic function into a three-dimensional image, the method comprising:
determining a horizontal misalignment between each tile and the plenoptic function projection;
correcting the horizontal misalignment by activating horizontal microactuators so as to adjust a horizontal position of the tile relative to the plenoptic function projection;
determining a vertical misalignment between each tile and the plenoptic function projection; and
correcting the vertical misalignment by activating vertical microactuators so as to adjust a vertical position of the tile relative to the plenoptic function projection.

7. The method of claim 6, wherein said misalignment determinations are performed by alignment pattern detectors and alignment patterns.

8. The method of claim 7, wherein the alignment pattern detectors include vertical sensors configured to determine said horizontal misalignment and horizontal sensors configured to determine said vertical misalignment.

9. The method of claim 7, wherein the alignment pattern detectors are coupled with said tiles and the alignment patterns are incorporated with the plenoptic function projection.

10. The method of claim 7, wherein the alignment pattern detectors are coupled with the plenoptic function projection and the alignment patterns are incorporated with said tiles.

11. The method of claim 6, wherein the microactuators are coupled to the tiles.

12. The method of claim 11, wherein the microactuators comprise micromotors having controllable screw mechanisms.

13. The method of claim 6, wherein the optical arrangement comprises an array of lenses.

14. An apparatus for automated alignment of a plenoptic three-dimensional display, the apparatus comprising:
an optical arrangement for transforming a plenoptic function projection into a three-dimensional image;
a plurality of tiles, each tile holding a section of the plenoptic function projection;
alignment detectors for determining misalignment between each tile and the optical arrangement; and
actuators for correcting any detected misalignment by adjusting a position of each tile relative to the optical arrangement.

15. The apparatus of claim 14, wherein the alignment detectors are coupled with the optical arrangement.

16. The apparatus of claim 15, further comprising alignment patterns that are incorporated into the sections of the plenoptic function projection.

17. The apparatus of claim 16, wherein the alignment detectors include vertical sensors configured to determine said horizontal misalignment and horizontal sensors configured to determine said vertical misalignment.

18. The apparatus of claim 14, wherein the actuators are coupled to the tiles and comprise micromotors having controllable screw mechanisms.

19. The apparatus of claim 14, wherein the optical arrangement comprises an array of lenses.

20. A method for automated alignment of a plurality of tiles to an optical arrangement, wherein each tile is configured to hold a section of a plenoptic function projection, and wherein the optical arrangement is configured to transform the plenoptic function projection into a three-dimensional image, the method comprising detecting a misalignment between each tile and the optical arrangment, and correcting any detected misalignment for a tile so as to adjust a position of the tile relative to the optical arrangement.
